(19) United States
(12) Patent Application Publication
(10) Pub. No.: US 2026/0036853 A1
(43) Pub. Date: Feb. 5, 2026

(54) DISPLAY DEVICE AND DISPLAY SYSTEM

(71) Applicant: Magnolia White Corporation, Tokyo (JP)

(72) Inventors: Hitoshi TANAKA, Tokyo (JP); Gen KOIDE, Tokyo (JP); Kyosuke WATANABE, Tokyo (JP); Jin HIROSAWA, Tokyo (JP); Junko NAGASAWA, Tokyo (JP)

(21) Appl. No.: 18/671,122

(22) Filed: May 22, 2024

(30) Foreign Application Priority Data
May 24, 2023 (JP) 2023-085799

(51) Int. Cl. G02F 1/1362

(52) U.S. Cl. CPC G02F 1/136209; G02F 1/136222; G02F 1/136286

(57) ABSTRACT

A display device includes an array substrate, and a counter substrate facing the array substrate. The array substrate includes a plurality of signal lines, a plurality of scanning lines, a color filter, a plurality of pixel electrodes, a common electrode, an insulating film, at least one spacer, and a conductive layer.

### CROSS-REFERENCE TO RELATED APPLICATION

This application claims the benefit of priority from Japanese Patent Application No. 2023-085799 filed on May 24, 2023, the entire contents of which are incorporated herein by reference.

### BACKGROUND

### 1. Technical Field

The present disclosure relates to a display device and a display system.

### 2. Description of the Related Art

Japanese Patent Application Laid-open Publication No. 2021-063897 (JP-A-2021-063897) discloses what is called a color filter on array (COA) structure in which a color filter, pixel electrodes, and a common electrode are disposed on an array substrate including switching elements.

To reduce the effects of overlapping misalignment between the array substrate and a counter substrate, the structure described in JP-A-2021-063897 has no color filter in a display region of the counter substrate. Therefore, the color filter is provided to the array substrate. In addition, a spacer that maintains the distance between the array substrate and the counter substrate may also cause overlapping misalignment with the array substrate. Therefore, a light-shielding region is required to suppress optical effects of the spacer if the spacer moves due to the overlapping misalignment with respect to the array substrate. If the pixel size is reduced, the light-shielding region corresponding to the spacer may possibly affect display.

An object of the present disclosure is to provide a display device and a display system that suppresses effects of a light-shielding region corresponding to a spacer on display.

### SUMMARY

A display device according to an embodiment includes an array substrate, and a counter substrate facing the array substrate. The array substrate includes a plurality of signal lines arrayed at intervals in a first direction, a plurality of scanning lines arrayed at intervals in a second direction, a color filter disposed at a position overlapping an opening surrounded by two adjacent signal lines and two adjacent scanning lines, a plurality of pixel electrodes provided to respective pixels, a common electrode serving as a translucent conductor overlapping the pixel electrodes with an insulating film interposed therebetween and having a slit formed corresponding to the opening, an insulating film that covers the color filter, at least one spacer that regulates a distance between the array substrate and the counter substrate, and a conductive layer with a grid shape stacked on the common electrode and extending along the signal lines and the scanning lines in plan view, the conductive layer has a light-shielding region provided with the spacer and where the width of the conductive layer is widened in at least one of the first direction and the second direction in plan view, and the slit does not overlap the light-shielding region.

A display system according to an embodiment includes a lens, the above display device, and a control device configured to output an image to the display device.

### BRIEF DESCRIPTION OF THE DRAWINGS

FIG. 1 is a configuration diagram of an example of a display system according to a first embodiment;

FIG. 2 is a schematic of an example of the relative relation between a display device and the eyes of a user;

FIG. 3 is a block diagram of an example of the configuration of the display system according to the first embodiment;

FIG. 4 is a circuit diagram of a pixel array in a display region according to the first embodiment;

FIG. 5 is an enlarged schematic of part of the display region according to the first embodiment;

FIG. 6 is a sectional view schematically illustrating the section along line VI-VI′ of FIG. 5;

FIG. 7 is a sectional view schematically illustrating the section along line VII-VII′ of FIG. 5;

FIG. 8 is a plan view schematically illustrating a light-shielding region corresponding to a spacer and slits according to the first embodiment;

FIG. 9 is a sectional view schematically illustrating the relation between the pixel array in the display region and the spacers according to the first embodiment;

FIG. 10 is a sectional view schematically illustrating the relation between the light-shielding region corresponding to the spacer and the slits according to a comparative example;

FIG. 11 is a sectional view schematically illustrating the boundary between the display region and a peripheral region according to the first embodiment;

FIG. 12 is a sectional view schematically illustrating the relation between the pixel array in the display region and the spacers according to a second embodiment;

FIG. 13 is a sectional view schematically illustrating the relation between the pixel array in the display region and the spacers according to a third embodiment;

FIG. 14 is a sectional view schematically illustrating the relation between the pixel array in the display region and the spacers according to a fourth embodiment;

FIG. 15 is a sectional view schematically illustrating the relation between the pixel array in the display region and the spacers according to a fifth embodiment;

FIG. 16 is a sectional view schematically illustrating the relation between the pixel array in the display region and the spacers according to a sixth embodiment;

FIG. 17 is a circuit diagram of the pixel array in the display region according to a seventh embodiment; and

FIG. 18 is a schematic of an example of a display panel according to the seventh embodiment.

### DETAILED DESCRIPTION

Exemplary aspects (embodiments) to embody the present invention are described below in greater detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the invention and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

### First Embodiment

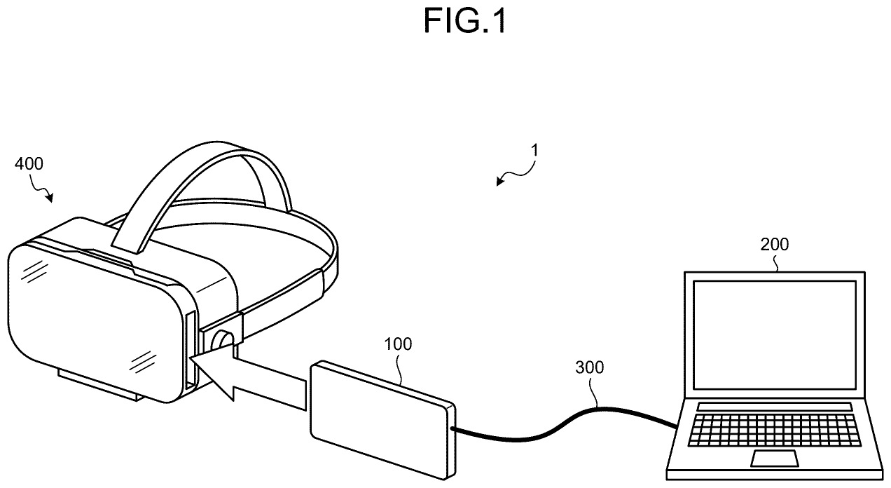

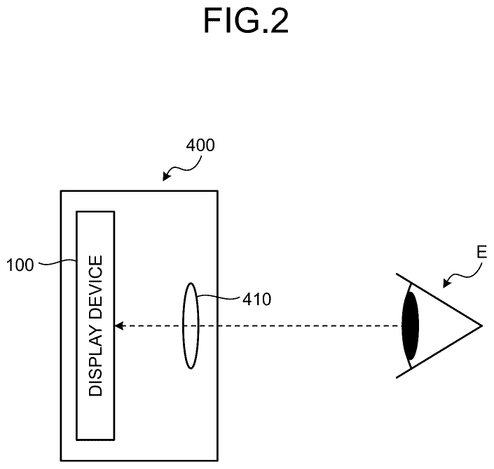

FIG. 1 is a configuration diagram of an example of a display system according to a first embodiment. FIG. 2 is a schematic of an example of the relative relation between a display device and the eyes of a user.

A display system 1 according to the present embodiment is a display system that changes images in synchronization with movement of the user. The display system 1 is, for example, a virtual reality (VR) system that three-dimensionally displays VR images indicating three-dimensional objects or the like in a virtual space and changes the three-dimensional images according to the direction (position) of the user's head, thereby creating a sense of virtual reality for the user.

The display system 1 includes a display device 100 and a control device 200, for example. The display device 100 and the control device 200 can receive and transmit information (signals) via a cable 300. Examples of the cable 300 include, but are not limited to, a universal serial bus (USB) cable, a high-definition multimedia interface (HDMI) (registered trademark) cable, etc. The display device 100 and the control device 200 may be capable of receiving and transmitting information through wireless communications.

The display device 100 is supplied with electric power from the control device 200 via the cable 300. The display device 100, for example, may include a power receiver supplied with electric power from a power supply unit of the control device 200 via the cable 300. In this case, display panels 110, a sensor 120, and other components of the display device 100 may be driven using the electric power supplied from the control device 200. With this configuration, the display device 100 does not require a battery or the like and can be provided as a more reasonable and lighter display device 100. Alternatively, a mounting member 400 or the display device 100 may be provided with a battery to supply electric power to the display device.

The display device 100 includes display panels. The display panel is a liquid crystal display, for example.

The display device 100 is fixed to the mounting member 400. Examples of the mounting member 400 include, but are not limited to, a headset, goggles, a helmet and a mask that cover both eyes of the user, etc. The mounting member 400 is mounted on the user's head. When the mounting member 400 is mounted, it is positioned in front of the user so as to cover both eyes of the user. The mounting member 400 functions as an immersive mounting member by positioning the display device 100 fixed inside in front of both eyes of the user. The mounting member 400 may include an output unit that outputs sound signals or the like output from the control device 200. The mounting member 400 may incorporate the functions of the control device 200.

While the display device 100 in the example illustrated in FIG. 1 is slotted into the mounting member 400, it may be fixed to the mounting member 400. In other words, the display system may be composed of a wearable display device including the mounting member 400 and the display device 100, and the control device 200.

As illustrated in FIG. 2, the mounting member 400 includes a lens 410 corresponding to both eyes of the user, for example. The lens 410 is a magnifying lens to form an image in the eyes of the user. When the mounting member 400 is mounted on the user's head, the lens 410 is positioned in front of the user's eyes E. The user visually recognizes a display region of the display device 100 magnified by the lens 410. Therefore, the display device 100 needs to increase the resolution to clearly display an image (screen). While the configuration according to the present disclosure includes one lens, for example, it may include a plurality of lenses, and the display device 100 may be positioned at a position other than in front of the eyes.

The control device 200, for example, displays images on the display device 100. The control device 200 may be an electronic apparatus, such as a personal computer and a gaming device. Examples of the virtual images include, but are not limited to, computer graphic video images, 360-degree real video images, etc. The control device 200 outputs a three-dimensional image created using the parallax of both eyes of the user to the display device 100. The control device 200 outputs images for the right eye and the left eye that follow the direction of the user's head to the display device 100.

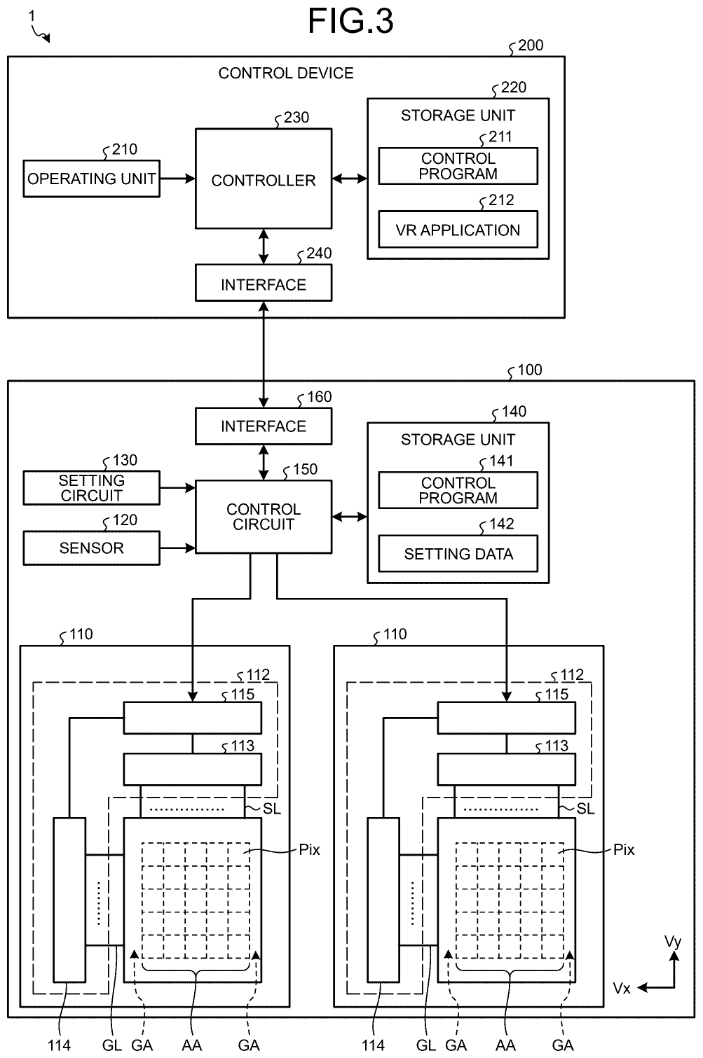

FIG. 3 is a block diagram of an example of the configuration of the display system according to the first embodiment. As illustrated in FIG. 3, the display device 100 includes two display panels 110, a sensor 120, an image separation circuit 150, and an interface 160.

The display device 100 is composed of two display panels 110: one is used as the display panel 110 for the left eye, and the other is used as the display panel 110 for the right eye.

The two display panels 110 each have a display region AA and a display control circuit 112. The display panel 110 includes a light source device, not illustrated, that irradiates the display region AA with light from behind.

In the display region AA, P₀×Q₀ pixels Pix (P₀ pixels Pix in the row direction and Q₀ pixels Pix in the column direction) are arrayed in a two-dimensional matrix (row-column configuration). In the present embodiment, Po is 2880, and Q₀ is 1700. FIG. 3 schematically illustrates the array of the pixels Pix, and the array of the pixels Pix will be described later in greater detail. The pixels of the display device are visually recognized through the lens. For this reason, the pixel pitch is 3 μm to 10 μm, for example, and the display region AA is composed of a high-definition array of the pixels Pix. The display region AA is surrounded by the peripheral region GA.

The display panel 110 includes scanning lines extending in an X-direction and signal lines extending in a Y-direction that intersects the X-direction. The display panel 110 includes 2880 signal lines SL and 1700 scanning lines GL, for example. In the display panel 110, the region surrounded by the signal lines SL and the scanning lines GL is provided with the pixel Pix. The pixel Pix includes a switching element SW (thin-film transistor (TFT)) coupled to the signal line SL and the scanning line GL, and a pixel electrode coupled to the switching element SW. One scanning line GL is coupled to a plurality of pixels Pix disposed along the extending direction of the scanning line GL. One signal line SL is coupled to a plurality of pixels Pix disposed along the extending direction of the signal line SL.

The display region AA of one display panel 110 of the two display panels 110 is for the right eye, and the display region AA of the other display panel 110 is for the left eye. The first embodiment describes a case where the display panel 110 includes the two display panels 110 for the left eye and the right eye. The display device 100, however, does not necessarily include two display panels 110 as described above. The display device 100, for example, may include one display panel 110. In this case, the display region of the display panel 110 may be divided into two parts such that the right half region displays images for the right eye and the left half region displays images for the left eye.

The display control circuit 112 includes a driver integrated circuit (IC) 115, a signal line coupling circuit 113, and a scanning line drive circuit 114. The signal line coupling circuit 113 is electrically coupled to the signal lines SL. The driver IC 115 causes the scanning line drive circuit 114 to control ON/OFF of the switching elements (e.g., TFT) for controlling the operation (light transmittance) of the pixels Pix. The scanning line drive circuit 114 is electrically coupled to the scanning lines GL.

The sensor 120 detects information that enables estimation of the direction of the user's head. The sensor 120, for example, detects information indicating the movement of the display device 100 and/or the mounting member 400, and the display system 1 estimates the direction of the head of the user wearing the display device 100 on the head based on the information indicating the movement of the display device 100 and/or the mounting member 400.

The sensor 120 detects the information that enables estimation of the direction of the line of sight using at least one of the angle, acceleration, angular velocity, azimuth, and distance of the display device 100 and/or the mounting member 400, for example. Examples of the sensor 120 include, but are not limited to, a gyro sensor, an acceleration sensor, an azimuth sensor, etc. The sensor 120 may detect the angle and angular velocity of the display device 100 and/or the mounting member 400 by a gyro sensor, for example. The sensor 120 may detect the direction and magnitude of acceleration acting on the display device 100 and/or the mounting member 400 by an acceleration sensor, for example. The sensor 120 may detect the azimuth of the display device 100 by an azimuth sensor, for example. The sensor 120 may detect the movement of the display device 100 and/or the mounting member 400 by a distance sensor or a global positioning system (GPS) receiver, for example. The sensor 120 may be any other sensor, such as an optical sensor, or a combination of a plurality of sensors, as long as it is a sensor that detects the direction of the user's head, changes in the line of sight, movement, or the like. The sensor 120 is electrically coupled to the image separation circuit 150 via the interface 160, which will be described later.

The image separation circuit 150 receives image data for the left eye and image data for the right eye transmitted from the control device 200 via the cable 300. The image separation circuit 150 transmits the image data for the left eye to the display panel 110 that displays images for the left eye and transmits the image data for the right eye to the display panel 110 that displays images for the right eye.

The interface 160 includes a connector to which the cable 300 (FIG. 1) is coupled. The interface 160 receives signals from the control device 200 via the coupled cable 300. The image separation circuit 150 outputs the signals received from the sensor 120 to the control device 200 via the interface 160 and an interface 240. The signals received from the sensor 120 include the information that enables estimation of the direction of the line of sight described above. Alternatively, the signals received from the sensor 120 may be output directly to a controller 230 of the control device 200 via the interface 160. The interface 160 may be a wireless communication device, for example, and transmit and receive information to and from the control device 200 through wireless communications.

The control device 200 includes an operating unit 210, a storage unit 220, the controller 230, and the interface 240.

The operating unit 210 receives operations of the user. The operating unit 210 is an input device, such as a keyboard, buttons, and a touch screen. The operating unit 210 is electrically coupled to the controller 230. The operating unit 210 outputs information corresponding to the operations to the controller 230.

The storage unit 220 stores therein computer programs and data. The storage unit 220 temporarily stores therein the results of processing by the controller 230. The storage unit 220 includes a storage medium. Examples of the storage medium include, but are not limited to, ROM, RAM, a memory card, an optical disc, a magneto-optical disc, etc. The storage unit 220 may store therein data of images to be displayed on the display device 100.

The storage unit 220 stores therein a control program 211 and a VR application 212, for example. The control program 211 can implement functions related to various controls for operating the control device 200, for example. The VR application 212 can implement functions to display virtual reality images on the display device 100. The storage unit 220, for example, can store therein various kinds of information, such as data indicating the detection results of the sensor 120, received from the display device 100.

Examples of the controller 230 include, but are not limited to, a micro control unit (MCU), a central processing unit (CPU), etc. The controller 230 can collectively control the operations of the control device 200. The various functions of the controller 230 are implemented based on the control by the controller 230.

The controller 230 includes a graphics processing unit (GPU) that generates images to be displayed, for example. The GPU generates images to be displayed on the display device 100. The controller 230 outputs the images generated by the GPU to the display device 100 via the interface 240. While the controller 230 of the control device 200 according to the present embodiment includes a GPU, the present embodiment is not limited thereto. For example, the GPU may be provided to the display device 100 or the image separation circuit 150 of the display device 100. In this case, the display device 100 acquires data from the control device 200 or an external electronic apparatus, for example, and the GPU generates the images based on the data.

The interface 240 includes a connector to which the cable 300 (refer to FIG. 1) is coupled. The interface 240 receives signals from the display device 100 via the cable 300. The interface 240 outputs signals received from the controller 230 to the display device 100 via the cable 300. The interface 240 may be a wireless communication device, for example, and may transmit and receive information to and from the display device 100 through wireless communications.

When the controller 230 executes the VR application 212, it displays an image corresponding to the movement of the user (display device 100) on the display device 100. When the controller 230 detects a change in the user (display device 100) while the image is being displayed on the display device 100, it changes the image being displayed on the display device 100 to an image in the direction of the change. When starting to create an image, the controller 230 creates an image based on a reference point of view and a reference line of sight in the virtual space. When the controller 230 detects a change in the user (display device 100), it changes the point of view or the line of sight when creating the image being displayed from the reference point view or the reference line of sight according to the movement of the user (display device 100). The controller 230 displays an image based on the changed point of view or line of sight on the display device 100.

For example, the controller 230 detects the movement of the user's head to the right direction based on the detection results of the sensor 120. In this case, the controller 230 changes the currently displayed image to an image obtained when the line of sight is moved to the right direction. The user can visually recognize the image in the right direction with respect to the image being displayed on the display device 100.

When the controller 230 detects the movement of the display device 100 based on the detection results of the sensor 120, for example, it changes the image according to the detected movement. If the controller 230 detects that the display device 100 has moved forward, it changes the currently displayed image to an image to be displayed when the display device 100 moves forward. If the controller 230 detects that the display device 100 has moved backward, it changes the currently displayed image to an image to be displayed when the display device 100 moves backward. The user can visually recognize the image in the direction of his/her movement from the image being displayed on the display device 100.

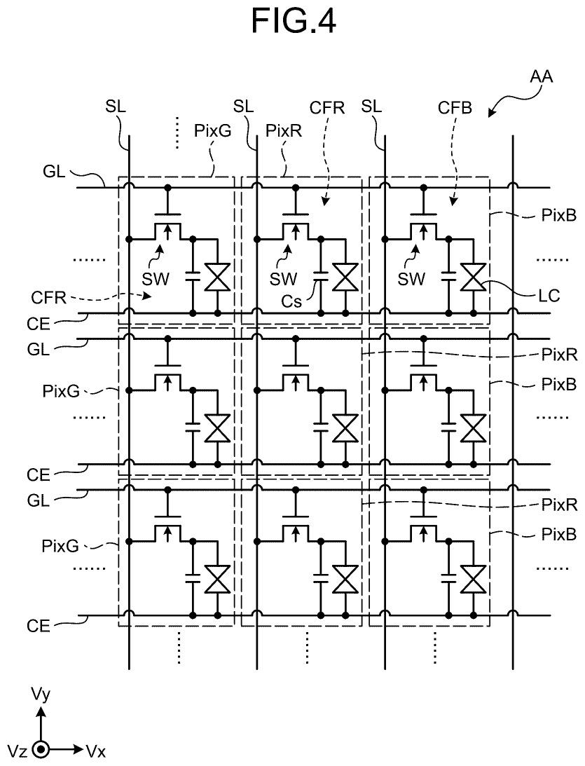

FIG. 4 is a circuit diagram of the pixel array in the display region according to the first embodiment. In the present disclosure, the scanning lines GL and the signal lines SL do not necessarily intersect at right angles, but they intersect at right angles in FIG. 3 for the convenience of explanation.

The pixel Pix illustrated in FIG. 4 is any one of the pixel PixR, the pixel PixG, and the pixel PixB. In the following description, the pixel PixR, the pixel PixG, and the pixel PixB are referred to as the pixels Pix when they are not distinguished from one another.

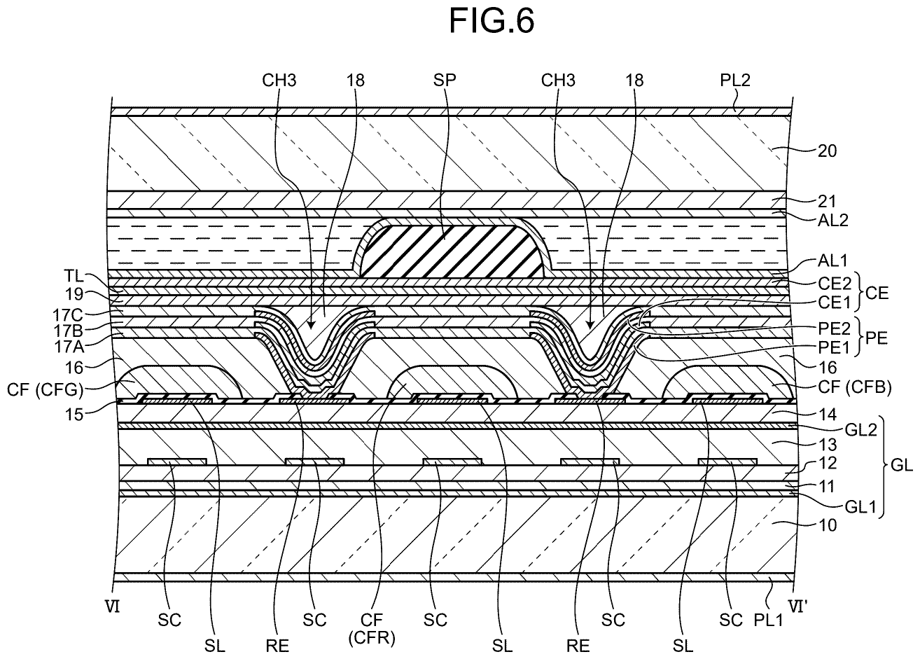

The display region AA is provided with the switching elements SW of pixels PixR, PixG, and PixB, the signal lines SL, the scanning lines GL, and other components as illustrated in FIG. 4. The signal line SL is wiring for supplying pixel signals to pixel electrodes PE (refer to FIG. 6). The scanning line GL is wiring for supplying gate signals that drive the switching elements SW.

As illustrated in FIG. 4, the pixels PixR, PixG, and PixB each include the switching element SW and capacitance of a liquid crystal layer LC. The switching element SW is composed of a thin-film transistor and is composed of an n-channel metal oxide semiconductor (MOS) TFT in this example. An insulating film is provided between the pixel electrode PE and a common electrode CE, which will be described later, and holding capacitance Cs illustrated in FIG. 4 is formed between the pixel electrode PE and the common electrode CE.

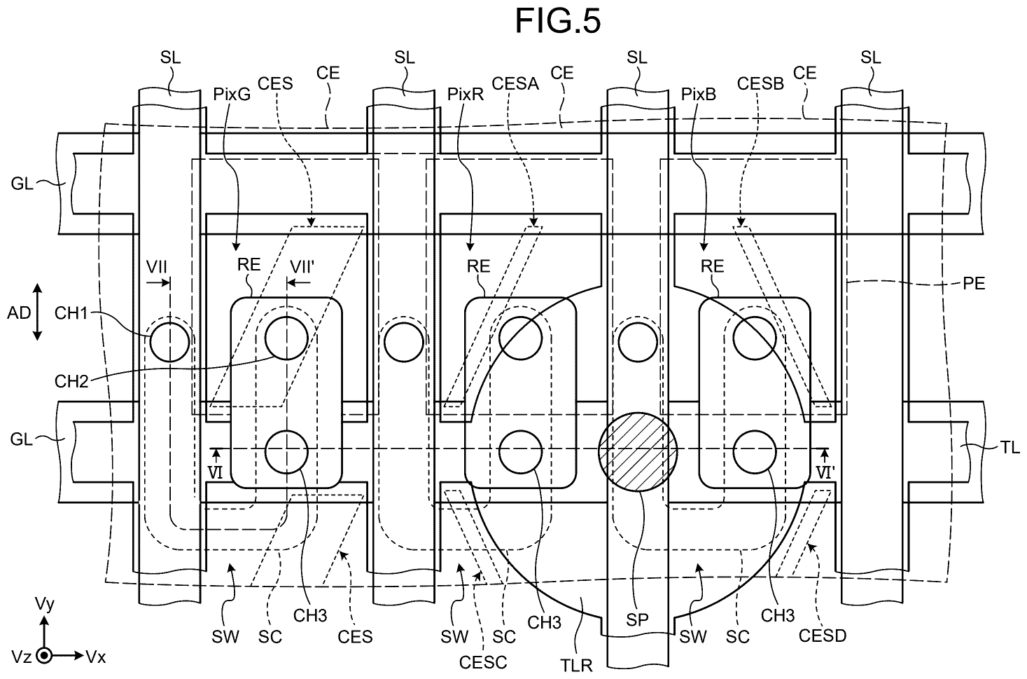

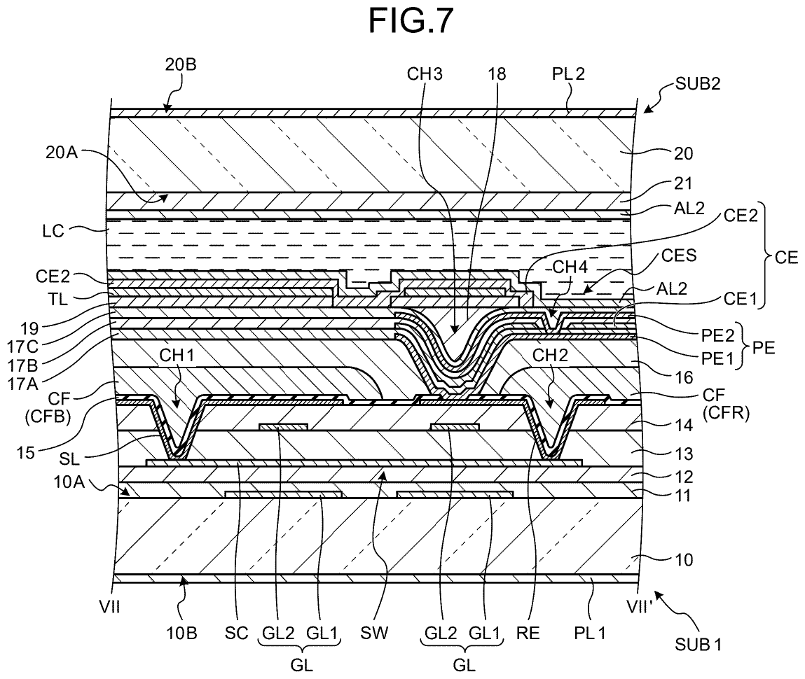

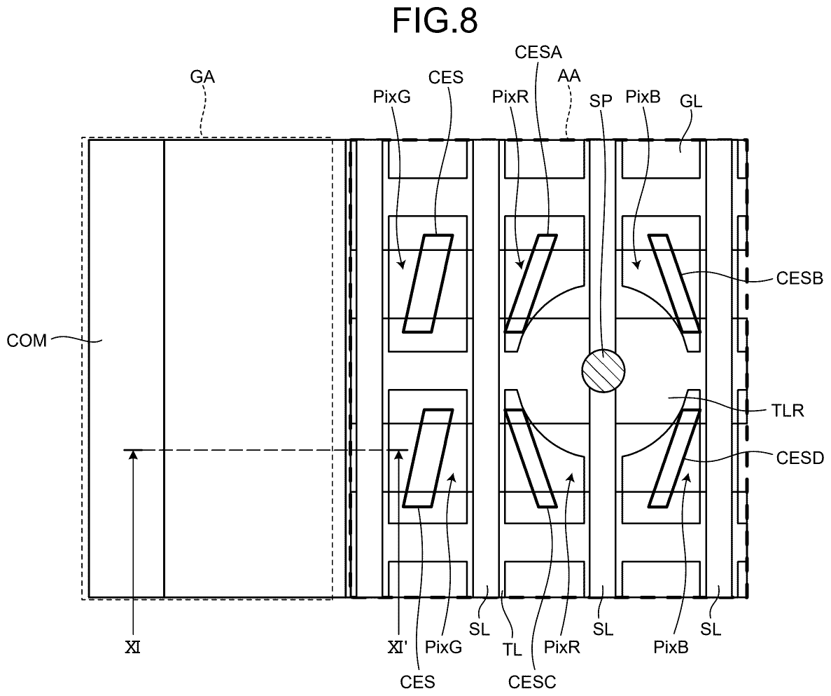

FIG. 5 is an enlarged schematic of part of the display region according to the first embodiment. FIG. 6 is a sectional view schematically illustrating the section along line VI-VI′ of FIG. 5. FIG. 7 is a sectional view schematically illustrating the section along line VII-VII′ of FIG. 5. FIG. 8 is a plan view schematically illustrating a light-shielding region corresponding to a spacer and slits according to the first embodiment.

A spacer SP illustrated in FIGS. 5 and 6 is a member that regulates the distance between an array substrate SUB1 and a counter substrate SUB2. The material of the spacer SP is acrylic resin, for example. The spacer SP has a cylindrical shape, and the maximum diameter of the spacer SP is illustrated in FIG. 5. The spacer SP does not necessarily have a cylindrical shape and may be formed as a prismatic spacer, for example. While one spacer is illustrated as an example in FIG. 5, a plurality of spacers are disposed in the actual configuration.

As illustrated in FIG. 5, the signal lines SL are arrayed in the direction Vx in a manner spaced apart from each other. The scanning lines GL are arrayed in the direction Vy in a manner spaced apart from each other. A conductive layer TL overlaps the signal lines SL and the scanning lines GL and has a grid shape in plan view. The width of the conductive layer TL in the direction Vx is larger than that of the signal line SL in the direction Vx. The width of the scanning line GL in the direction Vy is larger than that of the conductive layer TL in the direction Vy.

The spacer SP is disposed at part of the intersection where the signal line SL and the scanning line GL intersect. The position of the spacer SP may possibly vary due to overlapping misalignment with respect to the array substrate SUB1. If the spacer SP does not overlap the conductive layer TL, it causes optical noise. Therefore, the conductive layer TL according to the first embodiment includes a light-shielding region TLR that suppresses optical effects of the spacer SP.

The light-shielding region TLR is part of the conductive layer TL. The light-shielding region TLR has an outer periphery serving as circular arcs around the intersection of the signal line SL and the scanning line GL. If the size of the pixel Pix is reduced for higher resolution, the size of the light-shielding region TLR becomes relatively large. As a result, the light-shielding region TLR corresponding to the spacer SP makes the opening of the pixel Pix smaller. If the area of the light-shielding region TLR, which is calculated by considering the periphery of the light-shielding region TLR as a circle, is 80% or larger of the opening of the pixel Pix, a slit CES is likely to overlap the light-shielding region TLR.

In each pixel Pix, the pixel electrode PE and the switching element SW are disposed in the opening surrounded by two signal lines SL and two scanning lines GL. The common electrode CE is a common electrode provided across a plurality of pixels Pix. The common electrode CE has the slit CES, a slit CESA, and a slit CESB at each opening surrounded by two signal lines SL and two scanning lines GL. The slit CES is a part of the common electrode CE without translucent conductive material. The slit CES, the slit CESA, and the slit CESB each overlap the pixel electrode PE.

None of the slits CES, CESA, and CESB overlap the light-shielding region TLR. Therefore, the slit CESA in the pixel PixR formed avoiding the light-shielding region TLR in the pixel PixR has a smaller width in the direction Vx than the slit CES in the pixel PixG not provided with the light-shielding region TLR. The slit CESB in the pixel PixB formed avoiding the light-shielding region TLR in the pixel PixB has a smaller width in the direction Vx than the slit CES in the pixel PixG not provided with the light-shielding region TLR. The positions occupied by the light-shielding region TLR are different between the pixel PixR and the pixel PixB. As a result, the inclination in the longitudinal direction of the slit CES in the pixel PixR with respect to the direction Vy is different from that of the slit CES in the pixel PixB with respect to the direction Vy.

As illustrated in FIG. 5, a semiconductor SC is formed in a U-shape. As illustrated in FIG. 7, the signal line SL and the semiconductor SC are electrically coupled through a contact hole CH1. The semiconductor SC and a relay electrode RE are electrically coupled through a contact hole CH2. As illustrated in FIG. 6, the relay electrode RE and the pixel electrode PE are electrically coupled through a contact hole CH3.

As illustrated in FIGS. 6 and 7, a color filter CF according to the first embodiment is provided to the array substrate SUB1. The display device 100 has what is called a color filter on array (COA) structure in which the color filter CF, the pixel electrodes PE, and the common electrode CE are disposed on the array substrate SUB1.

As illustrated in FIGS. 6 and 7, the array substrate SUB1 is formed using a first insulating substrate 10 with translucency, such as a glass or resin substrate, as a base. The scanning line GL illustrated in FIG. 5 includes a gate electrode GL1 and a gate electrode GL2. The array substrate SUB1 includes the gate electrode GL1 of the scanning line GL, a first insulating film 11, a second insulating film 12, a third insulating film 13, the gate electrode GL2 of the scanning line GL, a fourth insulating film 14, the color filter CF, a fifth insulating film 15, a pixel electrode PE1, a sixth insulating film 16, a common electrode CE1, a seventh insulating film 17, a pixel electrode PE2, a first planarization film 18, a second planarization film 19, the conductive layer TL, a common electrode CE2, a first orientation film AL1, and other components on the surface of the first insulating substrate 10 facing the counter substrate SUB2. In the following description, the direction from the array substrate SUB1 toward the counter substrate SUB2 is referred to as an upper side or simply as up.

The gate electrode GL1 of the scanning line GL is positioned on the first insulating substrate 10. The first insulating film 11 is positioned on the gate electrode GL1 of the scanning line GL and an inner surface 10A of the first insulating substrate 10. The second insulating film 12 is positioned on the first insulating film 11. The semiconductor SC is positioned on the second insulating film 12. The third insulating film 13 is positioned on the semiconductor SC and the second insulating film 12. The gate electrode GL2 of the scanning line GL is positioned on the third insulating film 13.

The fourth insulating film 14 is positioned on the gate electrode GL2 of the scanning line GL and the third insulating film 13. A hole is formed at a position overlapping the semiconductor SC in the third insulating film 13 and the fourth insulating film 14 to form the contact hole CH1. The signal line SL formed on the fourth insulating film 14 is electrically coupled to the semiconductor SC through the contact holes CH1.

A hole is formed at a position overlapping the semiconductor SC in the third insulating film 13 and the fourth insulating film 14 to form the contact hole CH2. The relay electrode RE formed on the fourth insulating film 14 is electrically coupled to the semiconductor SC through the contact holes CH2.

The fifth insulating film 15 is positioned on the signal line SL, the relay electrode RE, and the fourth insulating film 14. The color filter CF is positioned on the fifth insulating film 15. The sixth insulating film 16 is positioned on the color filter CF and the fifth insulating film 15.

As illustrated in FIG. 6, a hole is formed at a position overlapping the relay electrode RE in the fifth insulating film 15 and the sixth insulating film 16 to form the contact hole CH3. The pixel electrode PE1 is electrically coupled to the relay electrode RE through the contact hole CH3. A first intermediate insulating film 17A is positioned on the sixth insulating film 16 and the pixel electrode PE1. The pixel electrode PE1 is made of translucent conductive material, such as indium tin oxide (ITO), indium zinc oxide (IZO), and indium gallium oxide (IGO).

The common electrode CE1 is positioned on the first intermediate insulating film 17A. The common electrode CE1 is made of translucent conductive material, such as ITO, IZO, and IGO. A second intermediate insulating film 17B is positioned on the common electrode CE1 and the first intermediate insulating film 17A. The pixel electrode PE2 is positioned on the second intermediate insulating film 17B. The pixel electrode PE2 is made of translucent conductive material, such as ITO, IZO, and IGO. A contact hole CH4 is formed in the second intermediate insulating film 17B. While the second intermediate insulating film 17B electrically insulates the pixel electrode PE2 from the common electrode CE1, the pixel electrode PE2 is electrically coupled to the pixel electrode PE1 through the contact hole CH4.

A third intermediate insulating film 17C is positioned on the pixel electrode PE2 and the second intermediate insulating film 17B. The first intermediate insulating film 17A, the second intermediate insulating film 17B, and the third intermediate insulating film 17C constitute the seventh insulating film.

In the contact hole CH3, a recess of the surface of the third intermediate insulating film 17C is formed, and the recess is planarized by the first planarization film 18. The second planarization film 19 is positioned on the third intermediate insulating film 17C and the first planarization film 18.

The first planarization film 18 is made of novolac resin or acrylic resin. The second planarization film 19 may be made of the same material as or different material from that of the first planarization film 18. The second planarization film 19 is an inorganic insulating film made of silicon nitride or an organic insulating film made of novolac resin or acrylic resin, for example.

The conductive layer TL is positioned on the second planarization film 19. The conductive layer TL is a metal conductor and is electrically coupled to the common electrode CE. Therefore, the resistance per unit area of the common electrode CE and the conductive layer TL is small. The conductive layer TL may be a single layer of metal, such as aluminum (Al). Alternatively, the conductive later TL may be composed of a plurality of metal layers, such as titanium/aluminum/titanium and molybdenum/aluminum/molybdenum, by disposing titanium (Ti) and molybdenum (Mo) on and under aluminum. The conductive layer TL has a light-shielding property due to thin-film interference.

The common electrode CE2 is positioned on the conductive layer TL and the second planarization film 19. The common electrode CE2 and the slit CES are covered by the first orientation film AL1.

The counter substrate SUB2 is formed using a second insulating substrate 20 with translucency, such as a glass or resin substrate, as a base. The counter substrate SUB2 includes an overcoat layer 21 and a second orientation film AL2 on the surface of the second insulating substrate 20 facing the array substrate SUB1.

The array substrate SUB1 and the counter substrate SUB2 are disposed with the first orientation film AL1 and the second orientation film AL2 facing each other. The liquid crystal layer LC is interposed between the first orientation film AL1 and the second orientation film AL2. The long axis of the liquid crystal molecules is oriented parallel to an initial orientation direction AD illustrated in FIG. 5 by the first orientation film AL1 and the second orientation film AL2. The liquid crystal layer LC is made of negative liquid crystal material with negative dielectric anisotropy or positive liquid crystal material with positive dielectric anisotropy.

The array substrate SUB1 faces a backlight unit, and the counter substrate SUB2 is positioned on the display surface side. While various kinds of backlight units are applicable, detailed description of their structure is omitted.

A first optical element OD1 including a first polarizing plate PL1 is disposed on an outer surface 10B of the first insulating substrate 10 or the surface facing the backlight unit. A second optical element OD2 including a second polarizing plate PL2 is disposed on an outer surface 20B of the second insulating substrate 20 or the surface on the observation position side. The first polarization axis of the first polarizing plate PL1 and the second polarization axis of the second polarizing plate PL2 are in a crossed-Nicoles positional relation in the Vx-Vy plane, for example. The first optical element OD1 and the second optical element OD2 may include other optical functional elements, such as a retardation plate.

If the liquid crystal layer LC is made of negative liquid crystal material, and no voltage is applied to the liquid crystal layer LC, for example, the liquid crystal molecules LM are initially oriented with their long axis extending in a direction along a predetermined direction in the Vx-Vy plane. By contrast, when voltage is applied to the liquid crystal layer LC, that is, in an ON state where an electric field is formed between the pixel electrode PE and the common electrode CE, the liquid crystal molecules LM are affected by the electric field, and their orientation state changes. In the ON state, the polarization state of incident linearly polarized light changes depending on the orientation state of the liquid crystal molecules LM as the linearly polarized light passes through the liquid crystal layer LC.

As illustrated in FIG. 5, none of the slits CES, CESA, and CESB overlap the light-shielding region TLR. Similarly, as illustrated in FIGS. 5 and 8, neither a slit CESC nor a slit CESD overlaps the light-shielding region TLR. Therefore, the slit CESA and the slit CESC in the pixel PixR formed avoiding the light-shielding region TLR in the pixel PixR have a smaller width in the direction Vx than the slit CES in the pixel PixG not provided with the light-shielding region TLR. The slit CESB and the slit CESD in the pixel PixB formed avoiding the light-shielding region TLR in the pixel PixB have a smaller width in the direction Vx than the slit CES in the pixel PixG not provided with the light-shielding region TLR.

The positions occupied by the light-shielding region TLR are different between the pixel PixR and the pixel PixB. As a result, the inclination in the longitudinal direction of the slit CESA in the pixel PixR with respect to the direction Vy is different from that of the slit CESB in the pixel PixB with respect to the direction Vy. As illustrated in FIG. 8, the light-shielding region TLR has circular arcs around the intersection of the signal line SL and the scanning line GL. Therefore, the slit CESA and the slit CESC in the pixels PixR adjacent to each other in the direction Vy are line-symmetric with respect to the scanning line GL. Similarly, the slit CESB and the slit CESD in the pixels PixB adjacent to each other in the direction Vy are line-symmetric with respect to the scanning line GL.

As illustrated in FIG. 8, in the pixel PixR and the pixel PixB adjacent to each other in the direction Vx, the slit CESA in the pixel PixR and the slit CESB in the pixel PixB are line-symmetric with respect to the signal line SL. In other words, in the pixel PixR and the pixel PixB adjacent to each other in the direction Vx, the extending direction in the longitudinal direction of the slit CESA in the pixel PixR is different from that of the slit CESB in the pixel PixB.

As illustrated in FIG. 8, in the pixel PixR and the pixel PixB adjacent to each other in the direction Vx, the slit CESC in the pixel PixR and the slit CESD in the pixel PixB are line-symmetric with respect to the signal line SL. In other words, in the pixel PixR and the pixel PixB adjacent to each other in the direction Vx, the extending direction in the longitudinal direction of the slit CESC in the pixel PixR is different from that of the slit CESD in the pixel PixB.

As illustrated in FIG. 8, in the pixels PixR adjacent to each other in the direction Vy, the slit CESA and the slit CESC are line-symmetric with respect to the signal line SL. In the pixels PixR adjacent to each other in the direction Vy, the extending direction in the longitudinal direction of the slit CESA is different from that of the slit CESC.

As illustrated in FIG. 8, in the pixels PixB adjacent to each other in the direction Vy, the slit CESC and the slit CESD are line-symmetric with respect to the signal line SL. In the pixels PixB adjacent to each other in the direction Vy, the extending direction in the longitudinal direction of the slit CESB is different from that of the slit CESD.

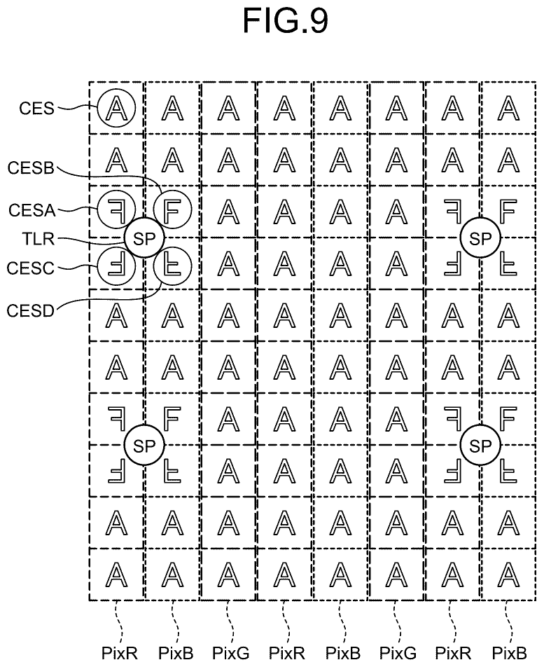

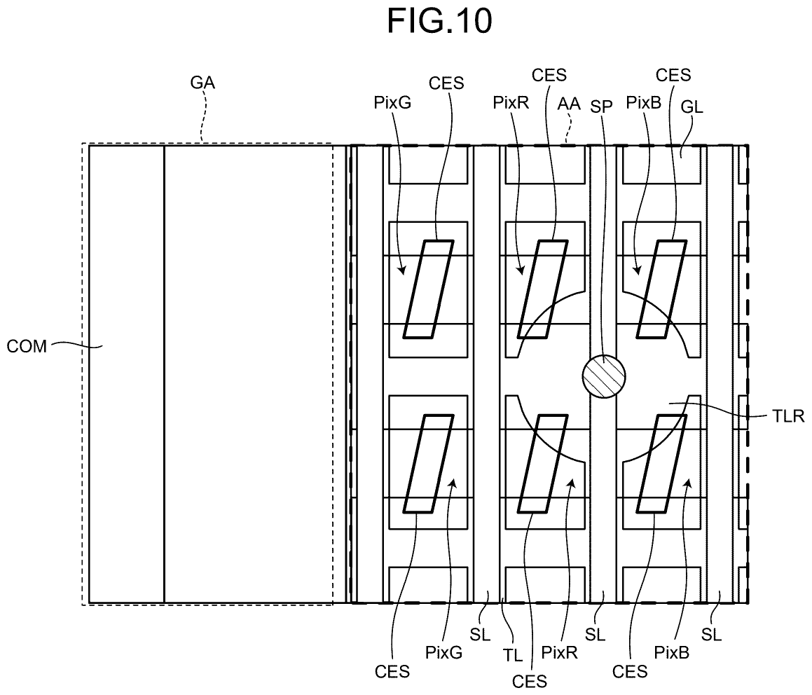

FIG. 9 is a sectional view schematically illustrating the relation between the pixel array in the display region and the spacers according to the first embodiment. FIG. 10 is a sectional view schematically illustrating the relation between the light-shielding region corresponding to the spacer and the slits according to a comparative example.

As illustrated in FIG. 9, a plurality of spacers SP are disposed at regular intervals. As described above, the pixels PixB and the pixels PixR around the spacer SP have the slit CESA, the slit CESB, the slit CESC, and the slit CESD. In FIG. 9, the slits CESA, CESB, CESC, and CESD are distinguished by the direction of the letter F. In the four pixels with which the light-shielding region TLR overlaps and that are adjacent to each other in the directions Vx and Vy, the extending directions in the longitudinal direction of the slits CESA, CESB, CESC, and CESD are different. The pixels Pix other than the pixels PixB and the pixels PixR around the spacer SP each have the slit CES. The pixel Pix having the slit CES is represented by the letter A.

As illustrated in FIG. 10, the light-shielding region TLR corresponding to the spacer SP according to the comparative example overlaps the slits CES. The light-shielding region TLR partially covers the slits CES. As a result, the portion without the conductive material is smaller in the slit CES with which the light-shielding region TLR overlaps than in the slit CES in the pixel PixG not provided with the light-shielding region TLR. The slits CESA and CESB around the light-shielding region TLR are affected by the distribution of the electric field along the circular arcs of the periphery of the light-shielding region TLR. As a result, the rotation of the liquid crystal molecules in the pixels PixR and PixB around the light-shielding region TLR is disturbed compared with the rotation of the liquid crystal molecules in the pixel PixG, and the light-shielding region TLR may affect display.

By contrast, none of the slits CESA, CESB, CESC, and CESD according to the first embodiment overlap the light-shielding region TLR corresponding to the spacer SP. The slits CESA, CESB, CESC, and CESD according to the first embodiment are less likely to be affected by the distribution of the electric field along the circular arcs of the periphery of the light-shielding region TLR.

As illustrated in FIG. 9, the area of the slit CES according to the first embodiment is larger than that of the slit CESA, CESB, CESC, or CESD according to the first embodiment. The slit CESA, CESB, CESC, or CESD according to the first embodiment is provided only around the spacer SP, so the number of slits CES according to the first embodiment is relatively larger than the number of slits CESA, CESB, CESC, or CESD according to the first embodiment. Therefore, the effects on the slit CESA, CESB, CESC, or CESD according to the first embodiment can be suppressed.

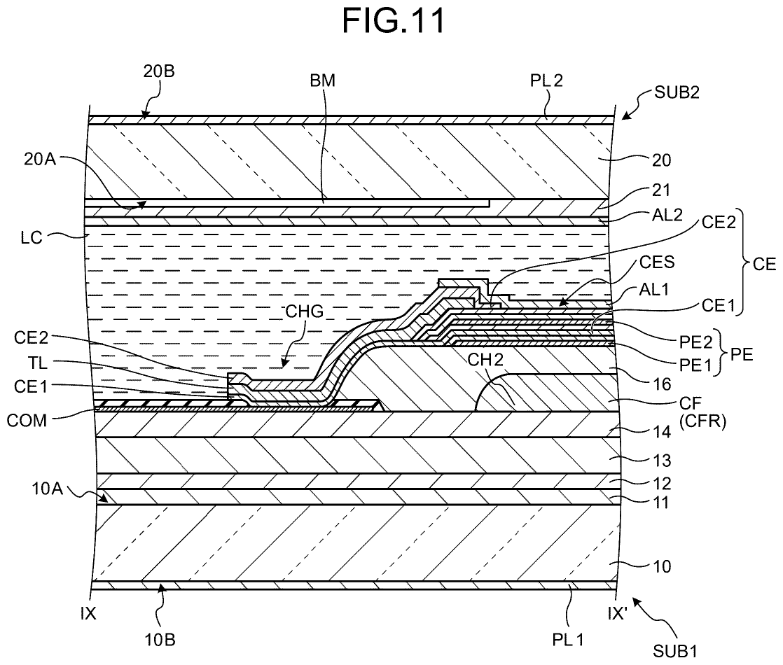

FIG. 11 is a sectional view schematically illustrating the boundary between the display region and the peripheral region according to the first embodiment. As illustrated in FIGS. 8 and 11, wiring COM for supplying a common potential is disposed on the fourth insulating film 14 in the peripheral region GA. The fifth insulating film 15 covers and protects the wiring COM. A contact hole CHG is formed in part of the fifth insulating film 15, and the wiring COM is electrically coupled to the common electrode CE1, the conductive layer TL, and the common electrode CE2 drawn from the display region AA through the contact hole CHG.

As illustrated in FIGS. 8 and 11, a light-shielding layer BM is provided to the counter substrate SUB2 in the peripheral region GA and can conceal the peripheral region GA of the array substrate SUB1. As illustrated in FIGS. 8 and 11, the light-shielding layer BM is not provided to the counter substrate SUB2 in the display region AA. The light-shielding layer BM is made of black resin material.

In the COA structure according to the first embodiment illustrated in FIGS. 8 and 11, the display region AA of the counter substrate SUB2 is not provided with the color filter CF or the light-shielding layer positioned at the boundary between the colors of the color filter CF. Therefore, light passing through the opening of the pixel Pix is not blocked if the pixel Pix is small.

As described above, the display device 100 includes the array substrate SUB1 and the counter substrate SUB2 facing the array substrate SUB1. The display region AA of the counter substrate SUB2 is provided with no light-shielding layer. This configuration reduces the effects of overlapping misalignment between the array substrate SUB1 and the counter substrate SUB2.

The array substrate SUB1 includes a plurality of signal lines SL arrayed at intervals in the direction Vx and a plurality of scanning lines GL arrayed at intervals in the direction Vy. The color filter CF of the array substrate SUB1 is disposed at a position overlapping the opening surrounded by two adjacent signal lines SL and two adjacent scanning lines GL. The array substrate SUB1 includes a plurality of pixel electrodes PE and a common electrode CE. The pixel electrodes PE are provided to the respective pixels Pix. The common electrode CE overlaps the pixel electrodes PE with an insulating film interposed therebetween. The common electrode CE has the slit CES, the slit CESA, the slit CESB, the slit CESC, and the slit CESD formed at the respective openings.

The sixth insulating film 16 covers the color filter CF. The contact hole CH3 is a recess formed in the sixth insulating film 16 and electrically couples the pixel electrode PE to the semiconductor SC via the relay electrode RE.

The conductive layer TL has the light-shielding region TLR provided with the spacer SP and where the width of the conductive layer is widened in both the directions Vx and Vy in plan view.

None of the slits CES, CESA, CESB, CESC, and CESD according to the first embodiment overlap the light-shielding region TLR. In the slits CESA, CESB, CESC, and CESD according to the first embodiment, the effects of the light-shielding region TLR are suppressed. As a result, the effects of the light-shielding region TLR corresponding to the spacer SP on display are suppressed.

### Second Embodiment

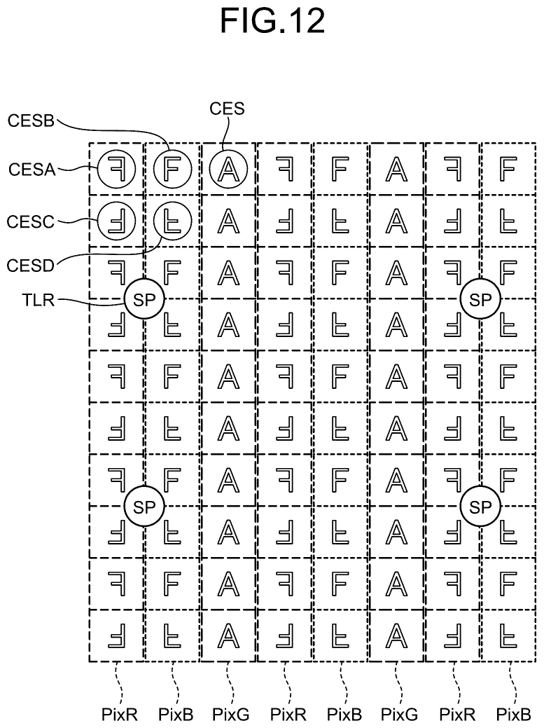

FIG. 12 is a sectional view schematically illustrating the relation between the pixel array in the display region and the spacers according to a second embodiment. In the following description, components similar to those according to the first embodiment are denoted by like reference numerals, and explanation thereof is omitted.

As illustrated in FIG. 12, a plurality of spacers SP are disposed at regular intervals. The pixels PixB and the pixels PixR around the spacer SP have the slits CESA, CESB, CESC, and CESD. In FIG. 12, the slits CESA, CESB, CESC, and CESD are distinguished by the direction of the letter F. Not only the pixels PixR around the spacer SP but also the pixels PixR around which no spacer SP is provided have the slit CESA and the slit CESC. Not only the pixels PixB around the spacer SP but also the pixels PixB around which no spacer SP is provided have the slit CESB and the slit CESD. The pixels PixG each have the slit CES. The pixel Pix having the slit CES is represented by the letter A.

The area of the slit in the pixel with which the light-shielding region TLR does not overlap and having the same color as the pixel PixB and the pixel PixR with which the light-shielding region TLR overlaps is equal to the area of the slit with which the light-shielding region TLR overlaps. The areas of the slits in the pixels in the same color are equal, so the deterioration in display quality around the spacer SP is less noticeable.

### Third Embodiment

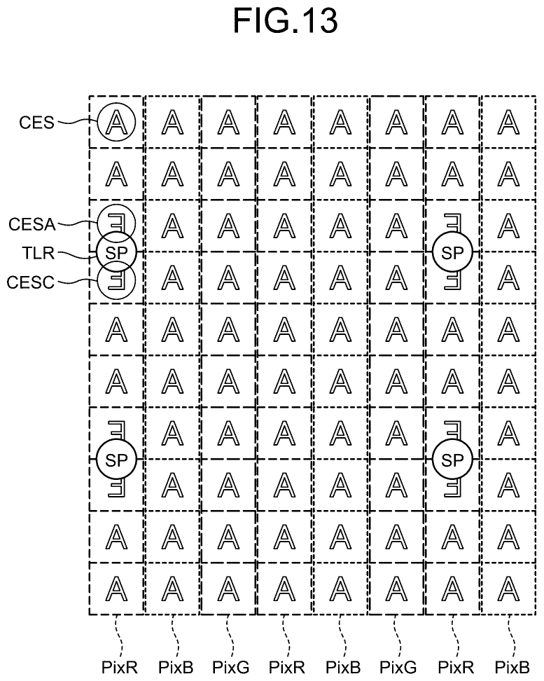

FIG. 13 is a sectional view schematically illustrating the relation between the pixel array in the display region and the spacers according to a third embodiment. In the following description, components similar to those according to the first and the second embodiments are denoted by like reference numerals, and duplicate explanation thereof is omitted.

The third embodiment is different from the first embodiment in that the spacer SP is not provided over two columns. As illustrated in FIG. 13, the spacer SP is disposed not on the signal line SL but on the scanning line GL.

As illustrated in FIG. 13, a plurality of spacers SP are disposed at regular intervals. The light-shielding regions are disposed at the respective portions provided with the spacer SP not overlapping the signal line SL but overlapping the scanning line GL. In other words, the conductive layer TL is widened in the direction Vy in the light-shielding region. The pixels PixR around the spacer SP have the slit CESA and the slit CESC. In FIG. 13, the slits CESA and CESC are distinguished by the direction of the letter F. The pixels PixR around which no spacer SP is provided each have the slit CES. The pixels PixB and PixG each have the slit CES. The pixel Pix having the slit CES is represented by the letter A.

### Fourth Embodiment

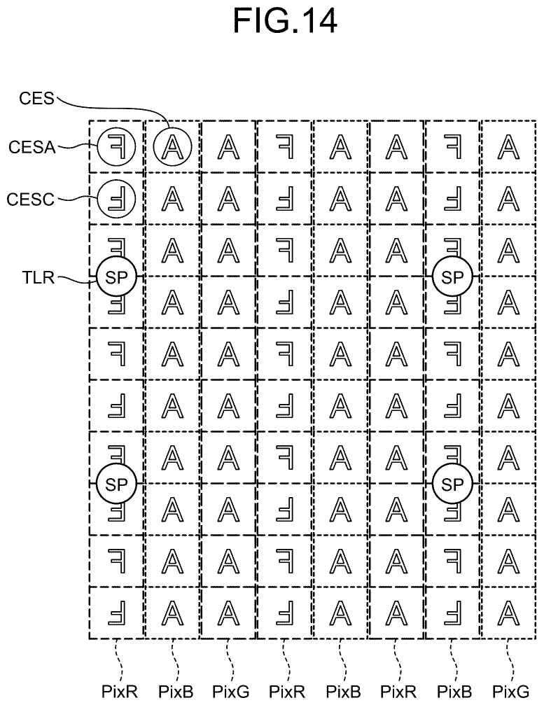

FIG. 14 is a sectional view schematically illustrating the relation between the pixel array in the display region and the spacers according to a fourth embodiment. In the following description, components similar to those according to the first and the second embodiments are denoted by like reference numerals, and duplicate explanation thereof is omitted.

The fourth embodiment is different from the third embodiment in that not only the pixels PixR around the spacer SP but also the pixels PixR around which no spacer SP is provided have the slit CESA and the slit CESB. As illustrated in FIG. 14, a plurality of spacers SP are disposed at regular intervals. The light-shielding regions are disposed at the respective portions provided with the spacer SP not overlapping the signal line SL but overlapping the scanning line GL. In other words, the conductive layer TL is widened in the direction Vy in the light-shielding region. The pixels PixR around the spacer SP have the slit CESA and the slit CESC. In FIG. 14, the slits CESA and CESC are distinguished by the direction of the letter F. The pixels PixR around which no spacer SP is provided have the slit CESA and the slit CESC. The pixels PixB and PixG each have the slit CES. The pixel Pix having the slit CES is represented by the letter A.

### Fifth Embodiment

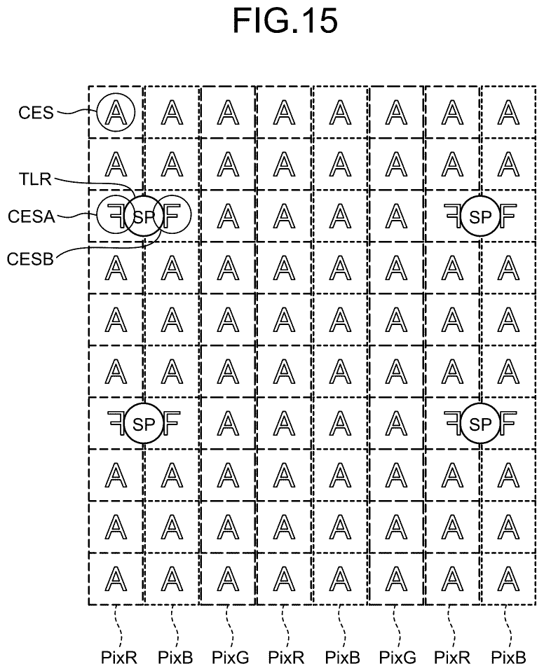

FIG. 15 is a sectional view schematically illustrating the relation between the pixel array in the display region and the spacers according to a fifth embodiment. In the following description, components similar to those according to the first and the second embodiments are denoted by like reference numerals, and duplicate explanation thereof is omitted.

The fifth embodiment is different from the first embodiment in that the spacer SP is not provided over two rows. As illustrated in FIG. 15, the spacer SP is disposed not on the scanning line GL but on the signal line SL.

As illustrated in FIG. 15, a plurality of spacers SP are disposed at regular intervals. The light-shielding regions are disposed at the respective portions provided with the spacer SP not overlapping the scanning line GL but overlapping the signal line SL. In other words, the conductive layer TL is widened in the direction Vx in the light-shielding region. The pixels PixB and PixR around the spacer SP have the slit CESA and the slit CESB. The slits CESA and CESB are distinguished by the direction of the letter F. The pixels PixR other than the pixels PixR around the spacer SP, the pixels PixB, and the pixels PixG each have the slit CES. The pixel Pix having the slit CES is represented by the letter A.

### Sixth Embodiment

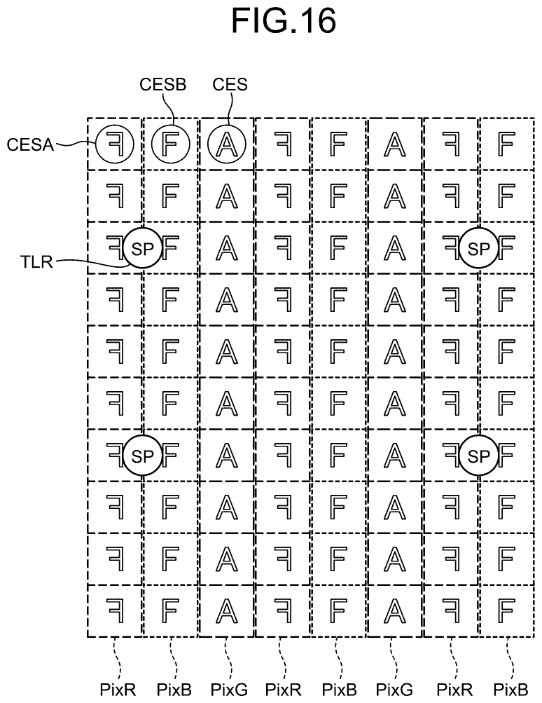

FIG. 16 is a sectional view schematically illustrating the relation between the pixel array in the display region and the spacers according to a sixth embodiment. In the following description, components similar to those according to the first to the fifth embodiments are denoted by like reference numerals, and duplicate explanation thereof is omitted.

The sixth embodiment is different from the fifth embodiment in that not only the pixels PixB and PixR around the spacer SP but also the pixels PixB and PixR around which no spacer SP is provided have the slit CESA and the slit CESC.

As illustrated in FIG. 16, a plurality of spacers SP are disposed at regular intervals. The light-shielding regions are disposed at the respective portions provided with the spacer SP not overlapping the scanning line GL but overlapping the signal line SL. In other words, the conductive layer TL is widened in the direction Vx in the light-shielding region. The pixels PixB and PixR around the spacer SP have the slit CESA and the slit CESB. The pixels PixB and PixR other than the pixels PixB and PixR around the spacer SP have the slit CESA and the slit CESB. The slits CESA and CESB are distinguished by the direction of the letter F. The pixel PixG having the slit CES is represented by the letter A.

### Seventh Embodiment

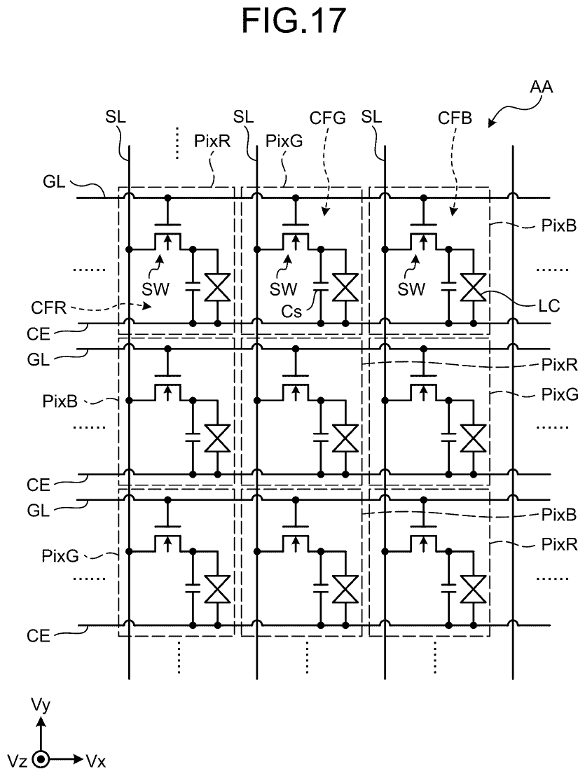

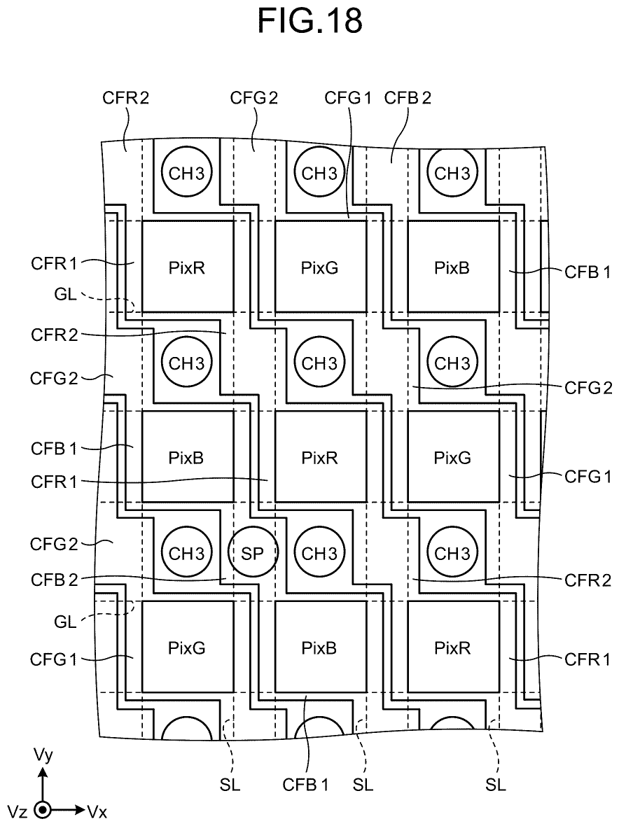

FIG. 17 is a circuit diagram of the pixel array in the display region according to a seventh embodiment. FIG. 18 is a schematic of an example of the display panel according to the seventh embodiment. In the following description, components similar to those according to the first to the sixth embodiments are denoted by like reference numerals, and duplicate explanation thereof is omitted.

The seventh embodiment is different from the first embodiment in the arrangement of the pixels PixR, PixG, and PixB.

As illustrated in FIG. 17, the pixel PixR is sandwiched between the pixel PixB and the pixel PixG in the direction Vx (first direction) and between the pixel PixB and the pixel PixG in the direction Vy (second direction).

The pixel PixG is sandwiched between the pixel PixR and the pixel PixB in the direction Vx and between the pixel PixR and the pixel PixB in the direction Vy.

The pixel PixB is sandwiched between the pixel PixG and the pixel PixR in the direction Vx and between the pixel PixG and the pixel PixR in the direction Vy.

The pixel PixR, the pixel PixG, and the pixel PixB are repeatedly arrayed in order in the direction Vx. The pixel PixR, the pixel PixB, and the pixel PixG are repeatedly arrayed in order in the direction Vy. In the arrangement in the direction Vy, the pixel PixR, the pixel PixG, and the pixel PixB may be repeatedly arrayed in order.

In a color filter CFR1, a color filter CFG1, and a color filter CFB1 illustrated in FIG. 18, color regions colored in three colors of red (first color: R), green (second color: G), and blue (third color: B), for example, are periodically arrayed. The three color regions, R, G, and B correspond to the pixels PixR, PixG, and PixB, respectively, illustrated in FIG. 17. A set of the pixels PixR, PixG, and PixB corresponding to the three color regions serves as a pixel. The color filter may include four or more color regions. The pixels PixR, PixG, and PixB may be referred to as sub-pixels.

The color filters CFR1, the color filter CFG1, and the color filter CFB1 illustrated in FIG. 18 are each provided to the opening surrounded by two signal lines SL and two scanning lines GL.

As illustrated in FIG. 18, the color filters CFR1 are coupled by a color filter CFR2 in the same red color. By coupling the color filters CFR1 and the color filters CFR2, the color filters in the same color are disposed in an oblique direction intersecting the direction Vx and the direction Vy. Similarly, the color filters CFG1 are coupled by a color filter CFG2 in the same green color, and the color filters CFB1 are coupled by a color filter CFB2 in the same blue color.

The color filter CFR1 and the color filter CFR2 are integrally formed. For the convenience of explanation, the color filter CFR1 and the color filter CFR2 are hereinafter referred to as a color filter CFR when they are not distinguished from each other. Similarly, the color filter CFG1 and the color filter CFG2 are hereinafter referred to as a color filter CFG when they are not distinguished from each other. The color filter CFB1 and the color filter CFB2 are hereinafter referred to as a color filter CFB when they are not distinguished from each other. Furthermore, the color filter CFR, the color filter CFG, and the color filter CFB are referred to as a color filter CF when they are not distinguished from one another.

While the exemplary embodiments have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure.

While the scanning line GL includes the gate electrode GL1 and the gate electrode GL2, for example, it may include only the gate electrode GL1 or the gate electrode GL2. While the common electrode CE includes the common electrode CE1 and the common electrode CE2, it may include only the common electrode CE1 or the common electrode CE2. While the pixel electrode PE includes the pixel electrode PE1 and the pixel electrode PE2, it may include only the pixel electrode PE1 or the pixel electrode PE2.

What is claimed is:

1. A display device comprising:
an array substrate; and
a counter substrate facing the array substrate, wherein
the array substrate comprises:
a plurality of signal lines arrayed at intervals in a first direction;
a plurality of scanning lines arrayed at intervals in a second direction;
a color filter disposed at a position overlapping an opening surrounded by two adjacent signal lines and two adjacent scanning lines;
a plurality of pixel electrodes provided to respective pixels;
a common electrode serving as a translucent conductor overlapping the pixel electrodes with an insulating film interposed therebetween and having a slit formed corresponding to the opening;
an insulating film that covers the color filter;
at least one spacer that regulates a distance between the array substrate and the counter substrate; and
a conductive layer with a grid shape stacked on the common electrode and extending along the signal lines and the scanning lines in plan view,
the conductive layer has a light-shielding region provided with the spacer and where the width of the conductive layer is widened in at least one of the first direction and the second direction in plan view, and
the slit does not overlap the light-shielding region.

2. The display device according to claim 1, wherein extending directions in the longitudinal direction of the slits in two pixels with which the light-shielding region overlaps and that are adjacent to each other in the first direction are different.

3. The display device according to claim 1, wherein extending directions in the longitudinal direction of the slits in two pixels with which the light-shielding region overlaps and that are adjacent to each other in the second direction are different.

4. The display device according to claim 1, wherein extending directions in the longitudinal direction of the slits in four pixels with which the light-shielding region overlaps and that are adjacent to each other in the first direction and the second direction are different.

5. The display device according to claim 1, wherein the area of the slit in a pixel with which the light-shielding region overlaps is different from the area of the slit in a pixel with which the light-shielding region does not overlap.

6. The display device according to claim 1, wherein the area of the slit in a pixel with which the light-shielding region does not overlap and having the same color as a pixel with which the light-shielding region overlaps is equal to the area of the slit with which the light-shielding region overlaps.

7. The display device according to claim 1, wherein the light-shielding region is disposed at each intersection provided with the spacer out of a plurality of intersections where the signal lines and the scanning lines intersect.

8. The display device according to claim 1, wherein the light-shielding region is disposed at each portion provided with the spacer not overlapping the signal line but overlapping the scanning line.

9. The display device according to claim 1, wherein the light-shielding region is disposed at each portion provided with the spacer not overlapping the scanning line but overlapping the signal line.

10. A display system comprising:
a lens;
the display device according to claim 1; and
a control device configured to output an image to the display device.
